(19) United States
(12) Patent Application Publication
(10) Pub. No.: US 2008/0314260 A1
(43) Pub. Date: Dec. 25, 2008

(54) DUAL DAMPER CONTROL APPARATUS AND METHOD

(76) Inventor: Paul Hardenburger, Hutchinson, KS (US)

Correspondence Address: HOVEY WILLIAMS LLP, 10801 Mastin Blvd., Suite 1000, Overland Park, KS, 66210, US

(21) Appl. No.: 11/767,403

(22) Filed: Jun. 22, 2007

(51) Int. Cl. A23B 4/044; A23B 4/00; F24F 13/10; F24F 13/15; F23L 13/00

(52) U.S. Cl. 99/476; 99/516; 454/335; 137/601.09; 126/285 R

(57) ABSTRACT

A dual damper assembly (44) having rotatable dampers (46, 48) operated in a predetermined relative phase relationship within separate passageways (34, 36) is provided for use with food treatment systems such as a smokehouse (20) in order to control the tendency of the dampers (46, 48) to flutter and thereby alter the desired relative orientation of the dampers (46, 48). The dual damper assembly (44) includes a drive assembly (50) serving to rotate the dampers (46, 48), as well as a brake assembly (52) operably coupled with one of the dampers (46, 48). The brake assembly (52) has a rotatable disc (76) secured to a damper rod extension (58a), with an associated caliper assembly (78) including brake pads (94, 96) engaging disc (76) in order to control damper flutter.

### BACKGROUND OF THE INVENTION

1. Field of the Invention

The present invention is broadly concerned with food treatment apparatus and systems such as smokehouses and chillers, characterized by forced-air treatment of food products with damper control and modulation of the forced-air currents. More particularly, it is concerned with such apparatus and systems including at least one dual damper assembly made up of first and second dampers rotated in a desired phase relationship, with a brake assembly operably coupled with at least one of the dampers in order to lessen damper flutter and the tendency of the dampers to operate out of phase.

2. Description of the Prior Art

Conventional smokehouses are designed to uniformly cook and process food products such as hot dogs, sausages, and hams. In such devices, the food to be processed is passed through a cooking/smoking zone while heated, smoke-laden, pressurized air currents are passed through the zone. It is important to establish and maintain uniform temperatures throughout the cooking/smoking zone in such operations. Otherwise, overheating of portions of the food product can occur before other portions thereof are brought to proper finishing temperature, resulting in product losses.

In an effort to achieve uniform cooking/smoking conditions, many existing smokehouses have a fan cabinet to generate pressurized air currents, with spaced apart, separate ducts leading to the cooking/smoking zone. A dual damper system is used in these devices, with an individual, rotatable damper located within each duct. The dual dampers are driven in a predetermined phase relationship, typically 90° out of phase, so that when one duct is fully closed, the other is fully open. The purpose of such an arrangement is to establish and maintain an optimum “break-point,” defined as the constantly moving point of turbulence where opposed air currents collide. As the alternating dampers rotate, one current of air increases in volume and velocity as the associated damper rotates to the full open position, while the opposite current of air decreases in volume and velocity as the associated damper moves to the full closed position. As can be appreciated, maintaining the predetermined phase orientation of the damper blades is critical for the creation and maintenance of the most effective break-point. If this phase orientation is lost, heat transfer efficiency to the food products is reduced, thus creating inconsistent cooking throughout the cooking/smoking zone. Further, cook times will be extended thus reducing the productivity of the equipment. A principal problem in this regard is the tendency of the dampers to “flutter” during operation. Flutter is created during damper rotation under the influence of pressurized air currents, and results in rapid, reversing rotational movement of the damper blades which compromises the desired relative blade orientation.

In many alternating damper systems the dampers are driven by a chain drive arrangement between the drive motor and first damper, and between the spaced apart damper rods. The use of two chains in such designs creates damper control break-point problems. First, the user must constantly maintain chain tightness in each chain in order to minimize damper flutter. Moreover, chains inherently have some built-in degree of looseness, which further contributes to the flutter problem. In other cases the dampers in dual damper systems are driven by rigid drive lines. This assists in maintaining damper control, but even in such situations flutter can be a problem.

These same considerations apply in other types of forced-air food treatment systems, e.g., cookers or chillers.

A number of prior art patents describe smokehouses and related equipment making use of dual damper systems. See e.g., U.S. Pat. Nos. 2,625,095; 2,505,973; 2,640,414; 3,721,177; 4,307,286; and DE 2,342,949. Other references of background interest include U.S. Pat. Nos. 3,199,436; 2,832,278; 6,644,957; 6,537,146; 6,503,140; 4,263,842; 4,205,783; 4,185,770; 3,897,773; 3,805,884; 2,746,374; 2,856,131; 4,645,137; 2,693,917; and JP 4-337,133.

### SUMMARY OF THE INVENTION

The present invention overcomes the problems outlined above and provides dual damper assemblies designed for use in food treatment apparatus and systems such as smokehouses and chillers. Broadly speaking, the dual damper assemblies of the invention comprise first and second dampers each including an elongated, axially rotatable rod and a damper body secured to the rod for rotation therewith. A drive assembly is operably coupled with the first and second dampers for rotation thereof in a desired relative orientation, and a brake assembly is operably coupled with at least one of the dampers in order to lessen damper flutter tending to alter the desired relative damper orientation.

In preferred forms, the drive assembly includes a drive motor operably secured to the rod of the first damper, with a drive arrangement extending between and coupling the first and second damper rods. This drive arrangement may be in the form of a rigid drive rod, a drive chain, or any other suitable drive mechanism. The brake assembly comprises a rotatable disc element secured to one of the damper rods and rotatable therewith, and a caliper assembly engageable with the disc to brake the one damper rod. The caliper assembly typically includes a pair of spring-biased brake pads on opposite sides of and engageable with the disc.

The respective dampers can be oriented in any desired phase relationship, but most often a 90° or perpendicular relationship is established. This damper orientation is effectively maintained with a minimum of flutter owing to the presence of the brake assembly.

The present invention also pertains to food treatment apparatus and systems including the dual damper assemblies. Such apparatus commonly has a housing including walls defining a region for receiving food product to be treated, and first and second spaced apart air passageways in communication with the treatment region. A fan is also provided for generating air currents, and the dual damper assembly is arranged so that the dampers are respectively located within the individual passageways for air control.

### BRIEF DESCRIPTION OF THE DRAWINGS

FIG. 1 is a schematic elevational view of a smokehouse in accordance with the invention, equipped with the preferred dual damper apparatus;

FIG. 2 is a fragmentary view of the smokehouse of FIG. 1, and further showing the preferred orientation of the dual dampers thereof;

FIG. 3 is a perspective view depicting the dual damper apparatus, and with the surrounding housing structure shown in phantom;

FIG. 4 is a perspective view of the preferred dual damper assembly;

FIG. 5 is an elevational view of the braked damper forming a part of the dual damper assembly;

FIG. 6 is an enlarged, fragmentary perspective view illustrating the components of the preferred damper brake;

FIG. 7 is a fragmentary end view of the damper brake illustrated in FIG. 6;

FIG. 8 is a vertical sectional view taken along line 8-8 of FIG. 7 and illustrating the tension bolts of the damper brake caliper;

FIG. 9 is a vertical sectional view taken along line 9-9 of FIG. 7 and depicting the threaded adjusting rods of the damper brake caliper; and

FIG. 10 is a vertical sectional view taken along line 10-10 of FIG. 7 and depicting the mounting pins for the damper brake caliper.

### DETAILED DESCRIPTION OF THE PREFERRED EMBODIMENT

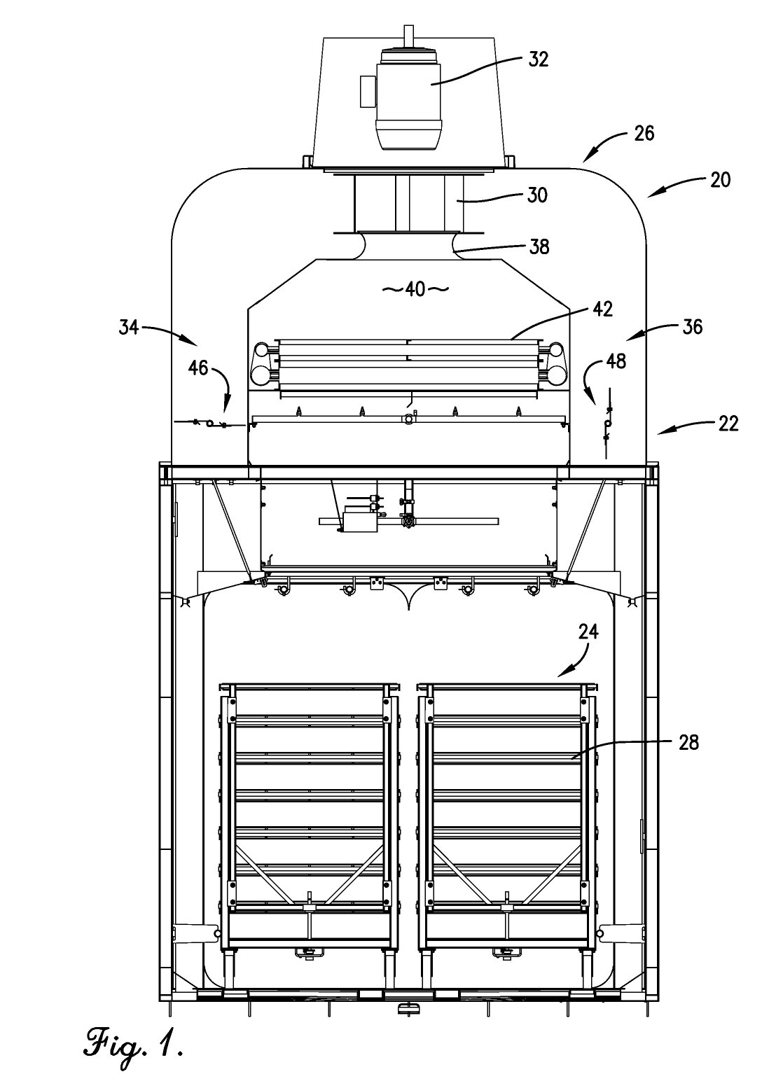

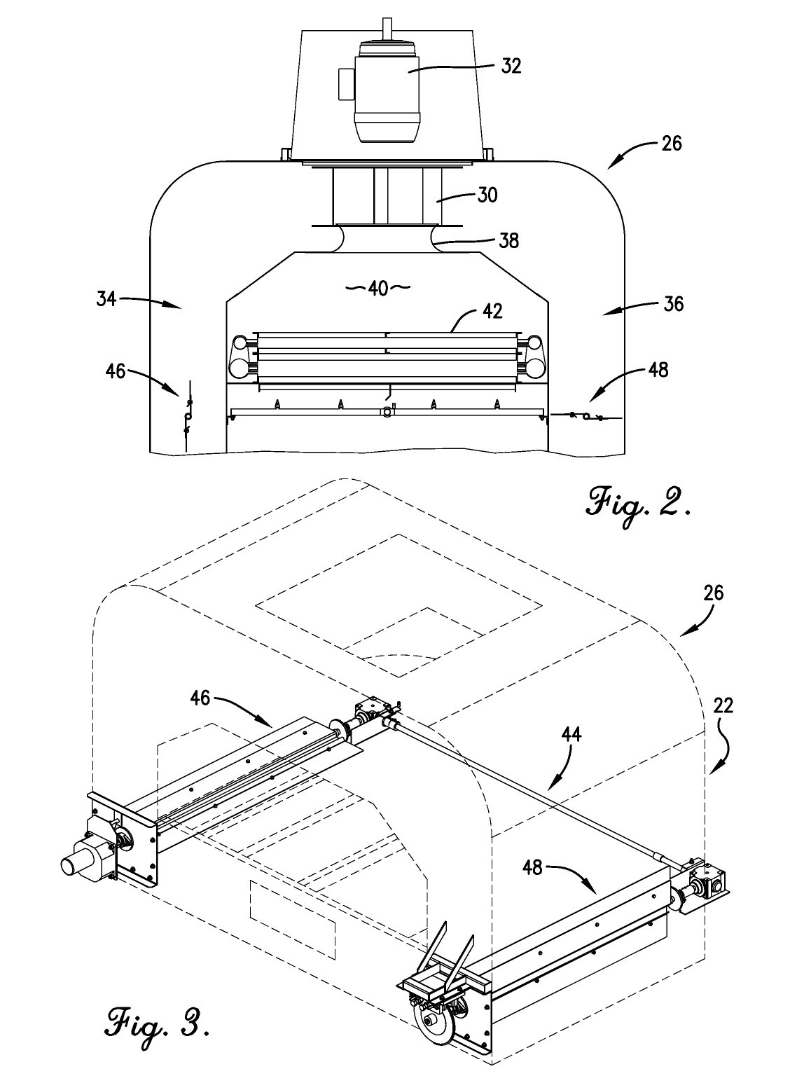

Turning now to the drawings, a smokehouse 20 is illustrated in FIG. 1 and broadly includes an upstanding housing 22 defining an internal region 24 for receipt of product to be processed, and an upper air handling cabinet or assembly 26. The region 24 is provided with a series of product carriers 28 designed to move product (e.g., sausages or hams) through the region 24, permitting the product to be processed. The air handling assembly 26 includes a fan 30 driven by motor 32, as well as marginal ducts or passageways 34 and 36 leading to region 24. The inlet of fan 30 is coupled with inlet cone 38 in communication with return duct 40. Steam coils 42 are situated within return duct 40 and serve to heat air passing from the region 24 upwardly through return duct 40 and into fan 30. The fan 30 serves to pressurize such air and deliver the heated and pressurized to the passageways 34, 36. Smoke ingredients may be added by atomizers (not shown) within region 24, or by any other conventional means. In operation, heated, pressurized, and smoke-laden air currents are directed through passageways 34, 36 and through the region 24; return air is directed upwardly through return duct 40 as previously explained.

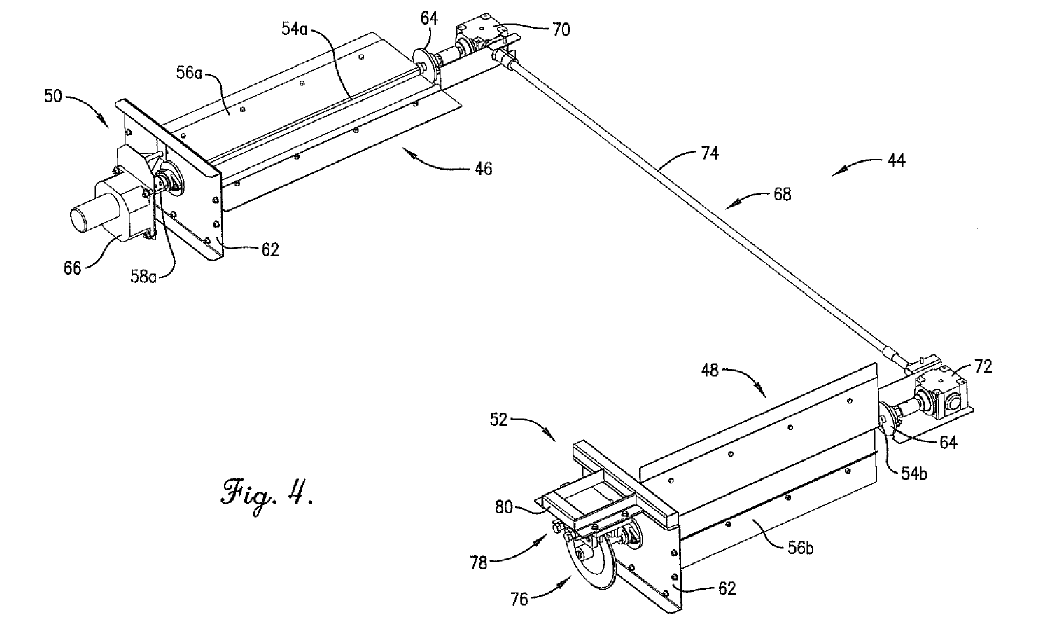

The overall air handling system 26 also includes a dual damper assembly 44 (see FIGS. 3-4) including first and second rotatable dampers 46 and 48 respectively located within the passageways 34, 36. The purpose of assembly 44 is to create and maintain the most effective break-point within the region 24 of smokehouse 20. This is accomplished by maintaining a desired phase relationship between the dampers 46, 48, in this case, maintenance of a substantially 90° phase difference between the dampers.

In more detail, the dual damper assembly 44 includes, in addition to first and second dampers 46 and 48, a drive assembly 50 operably coupled with the dampers 46, 48 for rotation thereof in the desired relative orientation, and a brake assembly 52 operably coupled with the damper 48 in order to lessen damper flutter which would otherwise tend to alter the desired relative orientation of the dampers 46, 48 during rotation.

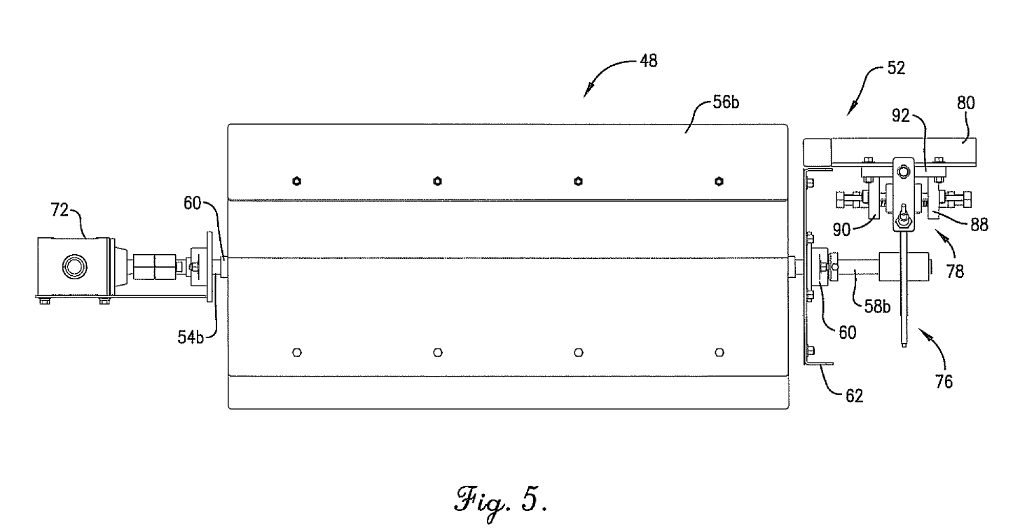

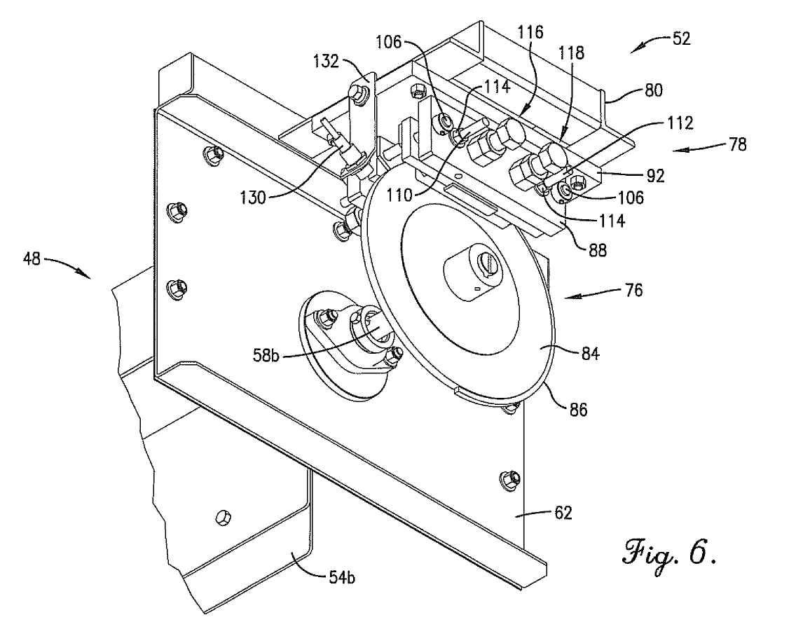

Each of the dampers 46 and 48 are substantially identical and include an elongated, central, axially rotatable rod 54a, 54b as well as a plate-like, substantially planar damper body 56a, 56b secured to the associated rod for rotation therewith. The rods 54a, 54b each include an extension 58a, 58b as best seen in FIGS. 5 and 6. The rods 54a, 54b are conventionally mounted for rotation via bearings 60 supported on end plates 62 and 64.

The drive assembly 50 includes a motor 66 coupled with extension 58a of rod 54a in order to drive damper 46, as well as a cross-drive assembly 68 for driving the opposed damper 48. The cross-drive assembly 68 includes right-angle gear boxes 70, 72 operatively coupled with the damper rods 54a, 54b, as well as drive line 74 interconnecting the gear boxes 70, 72. It will be appreciated that a chain drive could be used to interconnect the dampers 46, 48, in lieu of the assembly 68. It will be appreciated that actuation of motor 66 serves to rotate both dampers 46 and 48 during operation of smokehouse 20; typically, the dampers are rotated at a relatively low speed of 1-2 rpm. Furthermore, it will be observed that the dampers 46, 48 are initially positioned in the desired 90° out of phase relationship illustrated in FIG. 4.

The brake assembly 52 generally includes a brake disc 76 operably keyed to extension 58b, as well as a caliper assembly 78 supported on a bracket 80, the latter secured to the upper end of the plate 62 adjacent with damper 48. The disc 76 includes a pair of opposed, flattened braking surfaces 82, 84 as well as an outwardly extending shoulder 86 extending around approximately ½ of the periphery of the disc 76.

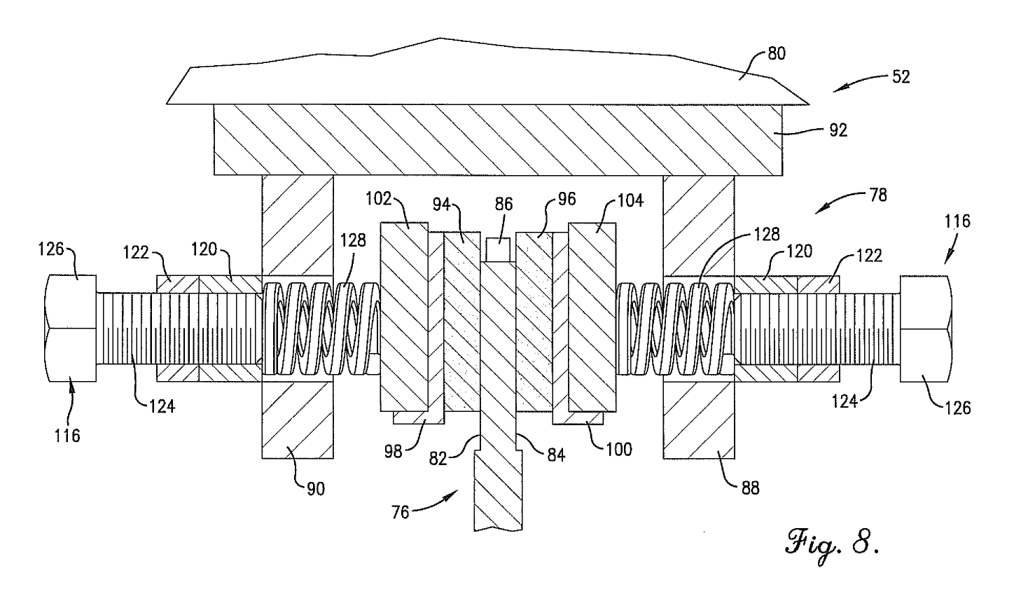

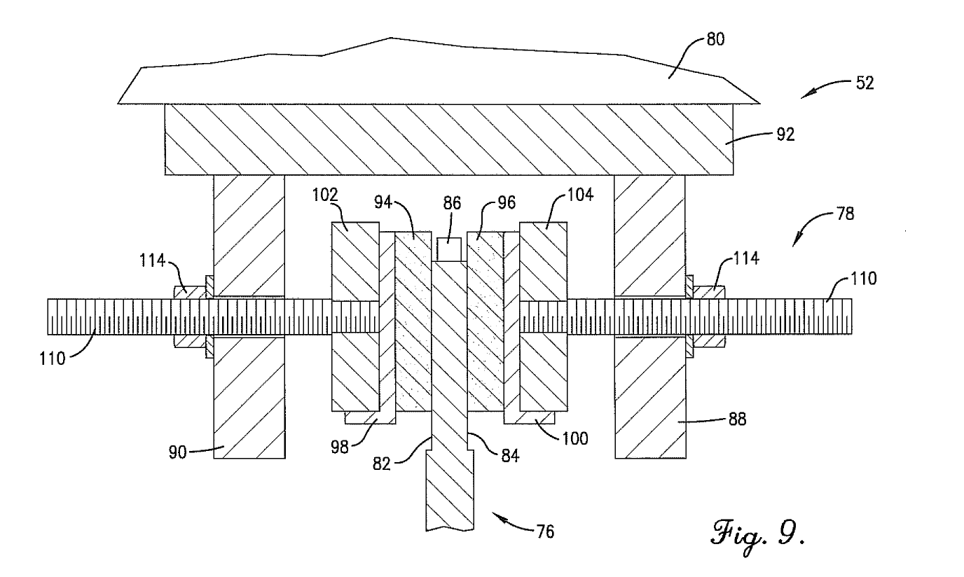

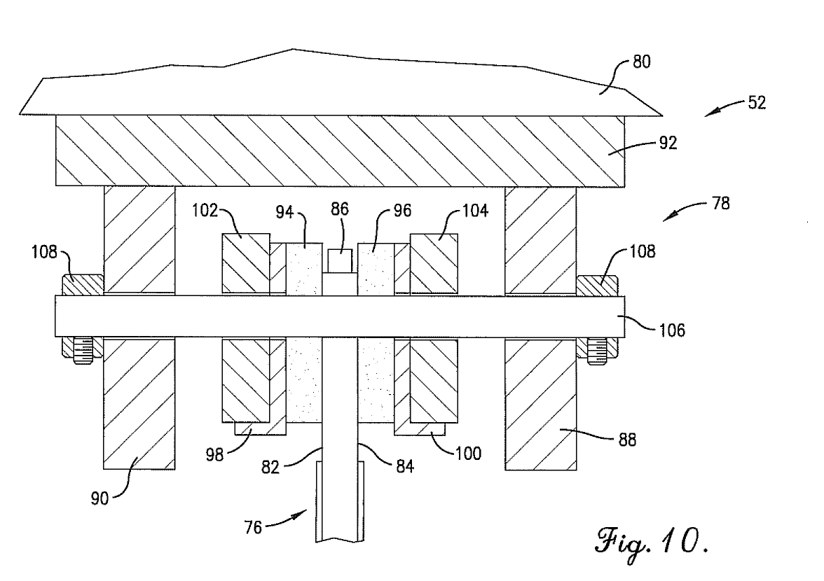

Caliper assembly 78 includes a pair of opposed, apertured mounting blocks 88 and 90 which depend from a cross-block 92 secured to the underside of bracket 80. The blocks 88, 90 in turn support a pair of brake pads 94, 96 oriented to engage the disc braking surfaces 82, 84. Each of the pads 94, 96 includes a somewhat L-shaped metallic support plate 98, 100 which also are attached to apertured pad mounts 102, 104. In order to support the brake pads 94, 96 and associated structure, a pair of spaced apart guide pins 106 (see FIG. 6) which extend through opposed openings in the blocks 88, 90. As illustrated, pins 106 also extend through the pad mounts 102, 104, plates 98, 100, and brake pads 94, 96. The outboard ends of each pin 106 are secured by means of set screw couplers 108. Each of the blocks 88, 90 also supports a pair of spaced apart, threaded assembly bolts 110, 112 which are threaded into the opposed pad mounts 102, 104 as shown. The bolts 110, 112 are secured by nuts 114 on the outer faces of the blocks 88, 90. Finally, each block 88, 90 also supports a pair of spaced apart tension bolt assemblies 116, 118 which bear against the pad mounts 102, 104 to urge the brake pads 94, 96 against disc surfaces 82, 84 (see FIG. 8). Each tension bolt assembly 116, 118 includes an internally threaded ferrule 120 and lock nut 122 receiving threaded shank 124 of bolt 126. Each assembly 116, 118 also includes a helical compression spring 128 situated between shank 124 and the outboard face of the adjacent pad mount 102 or 104. It will of course be appreciated that tightening of bolt 126 will increase the biasing force exerted against the pad mounts 102, 104, and thereby against the brake pads 94, 96.

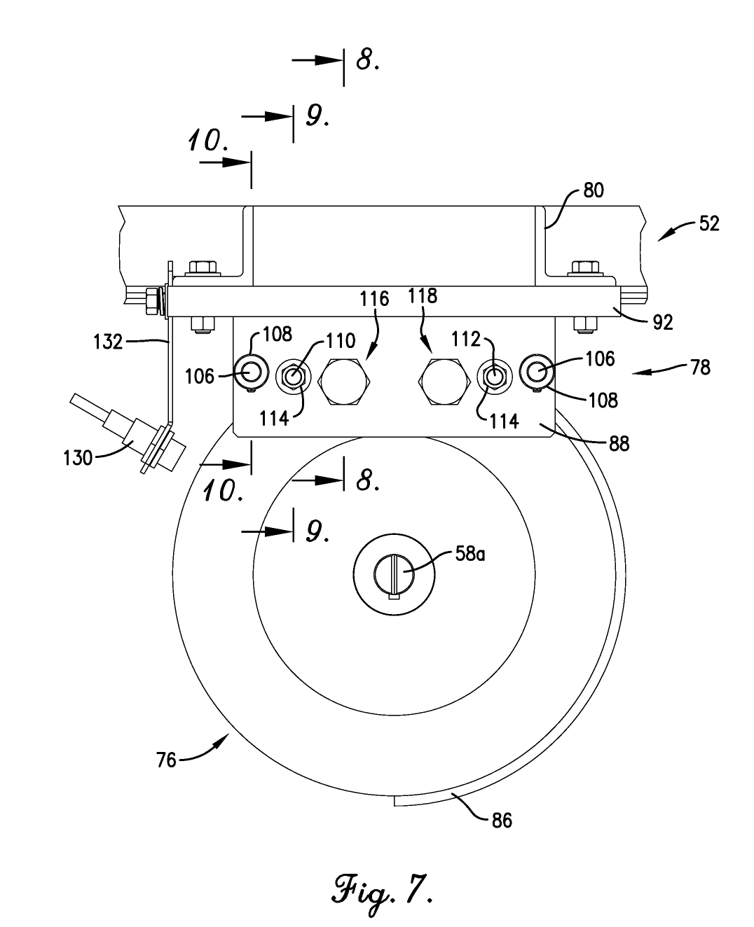

It will also be seen (FIGS. 6 and 7) that a proximity sensor 130 is mounted adjacent the disc 76 by means of a depending bracket 132 affixed to cross-block 92. The sensor 130 is designed to sense the shoulder 86 of disc 76 as will be explained.

The brake assembly 52 operably coupled with damper 48 serves to effectively minimize the extent of any damper flutter which would otherwise tend to alter the desired relative orientation of the damper bodies 56a, 56b during rotation thereof. This is accomplished by the biased engagement between the brake pads 94, 96 and the braking surfaces 82, 84 of disc 76, adjustable by the means of the tension bolt assemblies 116, 118. In this fashion the optimum break-point is established and maintained within the smokehouse 20.

In the operation of smokehouse 20, the fan 30 and steam coils 42 are continuously operated so as to direct heated air/smoke currents through the passageways 34, 36 for cooking/smoking of food products within region 24. At the same time, the dual damper assembly 44 is operated to slowly rotate the dampers 46, 48 within the passageways 34, 36. The perpendicular out-of-phase relationship between the respective dampers 46, 48 serves to alternate the air currents passing through the passageways 34, 36, i.e., the currents through one passageway increase in volume and velocity as the associated damper moves to the full-open position, and the currents through the opposite passageway diminish in volume and velocity as the associated damper moves to the full-closed position. This is the preferred relationship for proper break-point maintenance. The brake assembly 52 effectively limits any flutter within the dual damper assembly 44, so that the phase relationship between the dampers is maintained. Additionally, the caliper assembly 78 is mounted to float along the axis of the damper 48, thereby accommodating any linear movements due to thermal expansion and contraction. Accordingly, the brake assembly 52 properly functions regardless of the temperatures encountered during system operation. The proximity sensor 130 senses the presence or absence of shoulder 86 during rotation of disc 76. The sensor 130 is coupled with the control system for the smokehouse 20 and is designed to “look for” the shoulder signal over a given time period. If the signal is not received or remains present for a time period longer than a predetermined programmed time, an alarm (not shown) will sound, indicating that damper rotation has ceased and that service is required.

While the dual damper assembly 44 has been illustrated and described in the context of a smokehouse, the invention is not so limited. For example, the same dual damper assembly could be used in other types of heated-air cooking systems or in chillers. Accordingly, the present disclosure should be considered exemplary in nature and not limiting.

I claim:

1. A dual damper assembly comprising:
first and second dampers each including an elongated, axially rotatable rod and a damper secured to the rod for rotation therewith;
a drive assembly operably coupled with said first and second dampers for rotation thereof in a desired relative orientation; and
a brake assembly operably coupled with at least one of said dampers in order to lessen damper flutter tending to alter said desired relative orientation.

2. The damper assembly of claim 1, said drive assembly comprising a drive motor operably secured to the rod of said first damper, and a drive line extending between and coupling said first and second damper rods.

3. The damper assembly of claim 1, said brake assembly comprising a rotatable disc element secured to one of said damper rods and rotatable therewith, and a caliper assembly engageable with said disc to brake said one damper rod.

4. The damper assembly of claim 3, said caliper assembly comprising a pair of brake pads on opposite sides of and engageable with said disc.

5. The damper assembly of claim 4, including structure operable to urge each of said brake pads towards a side surface of said disc.

6. The damper assembly of claim 2, said one damper rod including an axial extension beyond the associated damper, said disc supported on said extension.

7. The damper assembly of claim 2, said disc carrying a sensor body, there being a proximity sensor adjacent said disc and operable to sense the sensor body during rotation of the disc.

8. The damper assembly of claim 1, each of said dampers comprising a substantially flat plate secured to the associated rod.

9. The damper assembly of claim 1, said first and second dampers being substantially 90° out of phase relative to each other.

10. A food treatment system, comprising:
a housing including walls defining a region for receiving food product to be treated, and first and second spaced apart air passageways in communication with said region;
a fan for generating air currents; and
a dual damper assembly including—
first and second dampers operably located adjacent said first and second air passageways, each of said first and second dampers including an elongated, axially rotatable rod, and a damper secured to said rod for rotation therewith;
a drive assembly operably coupled with said first and second dampers for rotation thereof in a desired relative orientation; and
a brake assembly operably coupled with at least one of said dampers in order to lessen damper flutter tending to alter said desired relative orientation,
said first and second dampers operable to continuously change the quantity of said air currents directed through said first and second passageways.

11. The food treatment system of claim 10, said drive assembly comprising a drive motor operably secured to the rod of said first damper, and a drive line extending between and coupling said first and second damper rods.

12. The food treatment system of claim 10, said brake assembly comprising a rotatable disc element secured to one of said damper rods and rotatable therewith, and a caliper assembly engageable with said disc to brake said one damper rod.

13. The food treatment system of claim 12, said caliper assembly comprising a pair of brake pads on opposite sides of and engageable with said disc.

14. The food treatment system of claim 13, including structure operable to urge each of said brake pads towards a side surface of said disc.

15. The food treatment system of claim 11, said one damper rod including an axial extension beyond the associated damper, said disc supported on said extension.

16. The food treatment system of claim 11, said disc carrying a sensor body, there being a proximity sensor adjacent said disc and operable to sense the sensor body during rotation of the disc.

17. The food treatment system of claim 10, each of said dampers comprising a substantially flat plate secured to the associated rod.

18. The food treatment system of claim 10, said first and second dampers being substantially 90° out of phase relative to each other.

19. The food treatment system of claim 10, said system being a smokehouse.
